(19) United States
(12) Patent Application Publication
(10) Pub. No.: US 2026/0170413 A1
(43) Pub. Date: Jun. 18, 2026

(54) LEARNING DEVICE, LEARNING METHOD, AND LEARNING PROGRAM

(71) Applicant: NEC Corporation, Tokyo (JP)

(72) Inventor: Yasuharu OKAMOTO, Tokyo (JP)

(73) Assignee: NEC Corporation, Tokyo (JP)

(21) Appl. No.: 19/405,741

(22) Filed: Dec. 2, 2025

(30) Foreign Application Priority Data
Dec. 17, 2024 (JP) 2024-220593

(51) Int. Cl. G06N 20/00; G06F 18/241

(52) U.S. Cl. CPC G06N 20/00; G06F 18/241

(57) ABSTRACT

The learning device includes a regularization unit that performs L0 regularization of features included in a learning model for binary classification constructed using logistic regression and a Factorization Machine by using an Ising model.

### CROSS REFERENCE TO RELATED APPLICATION

This application is based upon and claims the benefit of priority from the prior Japanese Patent Application No. 2024-220593, filed Dec. 17, 2024, the entire contents of which are incorporated herein by reference.

### BACKGROUND OF INVENTION

### Field of the Invention

This present disclosure relates to a learning device, a learning method, and a learning program.

### Description of the Related Art

In recent years, approaches using an Ising model have attracted attention as a solution method for combinatorial optimization problems of 0-1 binary variables (see Non-Patent Literature 1) and as a method to build learning models using FM (Factorization Machine) (see Non-Patent Literature 2).
[Non-Patent Literature 1] Lucas, A., “Ising formulations of many NP problems,” Front. Phys., 12, 00005 (2014).
[Non-Patent Literature 2] Kitai, K., Guo, J., Ju, S., Tanaka, S., Tsuda, K., Shiomi, J., & Tamura, R., “Designing metamaterials with quantum annealing and factorization machines,” Phys. Rev. Research 2, 013319 (2020).

### SUMMARY OF INVENTION

Learning models are broadly classified into regression models and classification models. For classification models, loss functions such as cross-entropy error and hinge loss are commonly used. However, because these loss functions are not quadratic expressions, it is difficult to directly perform optimization of a learning model by an Ising model, and the compatibility between the two is not good.

The present disclosure has been made in view of these problems. An example object of the disclosure is to provide a learning device, a learning method, and a learning program that enable a learning model for binary classification optimized using an Ising model.

A learning device according to an example aspect of the disclosure includes a regularization unit that performs L0 regularization of features included in a learning model for binary classification constructed using logistic regression and a Factorization Machine by using an Ising model.

A learning method according to an example aspect of the disclosure performed by a computer and includes performing L0 regularization of features included in a learning model for binary classification constructed using logistic regression and a Factorization Machine by using an Ising model.

A learning program according to an example aspect of the disclosure causes a computer to execute a regularization process that performs L0 regularization of features included in a learning model for binary classification constructed using logistic regression and a Factorization Machine by using an Ising model.

According to the present disclosure, it is possible to achieve a learning model for binary classification optimized using an Ising model.

### BRIEF DESCRIPTION OF THE DRAWINGS

FIG. 1 It is a block diagram to explain an example learning device.

FIG. 2 It is a flowchart to explain an example operation of the learning device.

FIG. 3 It is an explanatory diagram to explain an outline of the operation of the learning device.

FIG. 4 It is an explanatory diagram to explain an influence on accuracy when a hyperparameter alpha of a sigmoid function is adjusted.

FIG. 5A It is an explanatory diagram to explain a relation between the number of features (M) selected by L0 regularization and accuracy.

FIG. 5B It is an explanatory diagram to explain a relation between the number of features (M) selected by L0 regularization and accuracy.

FIG. 6 It is an explanatory diagram to explain an influence that a correction term of Equation (11) gives to accuracy.

FIG. 7 It is a block diagram to explain a hardware configuration of a computer that achieves the learning device.

FIG. 8 It is a block diagram to explain main parts of the learning device.

### DESCRIPTION OF THE PREFERRED EMBODIMENTS

The application targets of annealing methods are limited to Ising models composed of binary variables. In this field, regression models have often been used. However, in practical terms, classification models are considered to be as important as, or more important than, regression models. The present disclosure addresses contrivances to apply an Ising model composed of binary variables to classification models.

As a binary classification technique using an Ising model, QBoost for QUBO (Quantum Boosting for Quadratic Unconstrained Binary Optimization), which is ensemble learning of weak learners, can be cited (see Literature 3 below). However, this technique tends to have classification accuracy that depends on the accuracy of weak learners and is generally difficult to improve. Therefore, a different approach is required.
Literature 3: “6-Quantum annealing-based machine learning (QBoost),” [online], OpenJij Tutorial 0.3.0 documentation, [searched on Dec. 4, 2024], Internet URL: https://tutorial.openjij.org/build/html/ja/006-Machine_Learning_by_QA.html.

One object of the present disclosure is to propose, as a solution for binary classification using an Ising model, a technique having accuracy comparable to standard binary classification techniques. In the learning device of the present disclosure, L0 regularization using an Ising model is performed. This regularization is expected to improve generalization performance. In addition, because L0 regularization directly controls the number of features, it becomes clear which features are important and which are not. As a result, interpretability of the learning model is also expected to improve.

Hereinafter, example embodiments of the present disclosure are explained with reference to the drawings. In each drawing, the same or related elements are denoted by the same reference numerals, and to clarify the explanation, duplicate explanations are omitted as needed. Unless specifically explained otherwise, values predetermined such as predetermined values and thresholds are previously stored in a storage device accessible from the device that uses the values. Unless specifically explained otherwise, a storage unit is constituted by any number of one or more storage devices.

In the example embodiments below, even if superscripts and subscripts of variables are aligned in equations, in text they may be written with the superscripts and the subscripts shifted. Even in such a case, if the symbols of the variables, the superscripts, and the subscripts are the same, they represent the same variable.

### Example Embodiment 1

### [Explanation of Configuration]

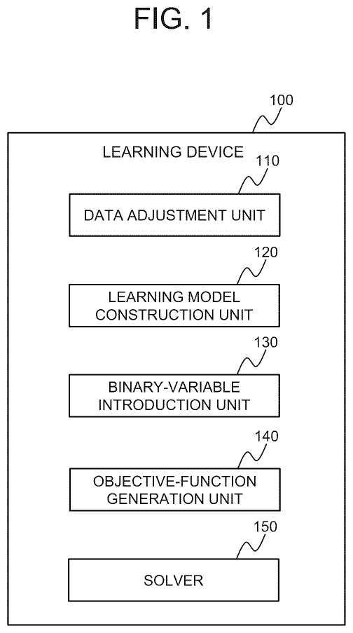

The present example embodiment explains the learning device. FIG. 1 is a block diagram to explain a learning device by way of example. The learning device 100 of the present example embodiment includes a data adjustment unit 110, a learning model construction unit 120, a binary-variable introduction unit 130, an objective-function generation unit 140, and a solver 150.

The data adjustment unit 110 has a function to input data having a plurality of features serving as classification targets and to convert the data into a format suitable for FM learning and optimization by an Ising model. Specifically, the data adjustment unit 110 converts categorical variables into one-hot vectors for FM learning and optimization by an Ising model. The data adjustment unit 110 also randomly divides the entire data into training data and test data.

The learning model construction unit 120 has a function to construct a learning model for binary classification. The learning model construction unit 120 constructs, for example, a learning model for binary classification using logistic regression and FM. The learning model construction unit 120 can uniformly adjust the entire argument of the exponential function in logistic regression by a hyperparameter (for example, a hyperparameter alpha described later).

The binary-variable introduction unit 130 has a function to introduce binary variables into the constructed learning model. For example, the binary-variable introduction unit 130 introduces 0-1 binary variables that represent selection or non-selection for each first-order term and each second-order term of the learning model constructed by the learning model construction unit 120. By using these 0-1 binary variables, the coefficients of the first-order terms and the second-order terms are controlled, and selection (when the value of a 0-1 binary variable is 1) or non-selection (when the value of a 0-1 binary variable is 0) of features is achieved.

The objective-function generation unit 140 has a function to generate an objective function that is the target of optimization (minimization) by an Ising model, based on the learning model into which binary variables are introduced. Specifically, the objective-function generation unit 140 converts the problem of regularizing the constructed learning model into a combinatorial optimization problem described in QUBO form. This combinatorial optimization problem is a problem of selecting a combination of 0-1 binary variables that minimizes the objective function.

The objective-function generation unit 140 introduces into the objective function a penalty function for setting the total number of selected features (terms). The strength of the penalty function is adjusted by a hyperparameter (for example, a hyperparameter A described later). The objective-function generation unit 140 also introduces into the objective function a correction term that reflects classification results (success/failure) by the L0-regularized learning model. The strength of the correction term is adjusted by a hyperparameter (for example, a hyperparameter B described later).

The solver 150 has a function to solve the combinatorial optimization problem. The solver 150 also has a function to output a solution of the solved combinatorial optimization problem. For example, for features included in the constructed learning model, the solver 150 outputs the solution of the solved combinatorial optimization problem as feature selection results.

In the present example embodiment, the objective-function generation unit 140 generates an objective function based on the learning model into which binary variables are introduced and converts the problem of regularizing the constructed learning model into a combinatorial optimization problem that selects a combination of binary variables that minimizes the objective function described in QUBO form. As a solution method for the combinatorial optimization problem, the solver 150 explores a combination of binary variables that minimizes the objective function by using, for example, simulated annealing or quantum annealing.

The learning device 100 of the present example embodiment has features A to D below.

A: The learning device 100 constructs a classification model in a general framework of logistic regression using a sigmoid function and cross-entropy.

B: The learning device 100 sets the argument part of the sigmoid function to an FM-based quadratic learning model f_{FM}(xⁱ) and introduces a hyperparameter alpha (hereinafter also referred to as “gain”) that adjusts the overall magnitude of the f_{FM}(xⁱ), thereby improving classification accuracy.

C: The learning device 100 introduces 0-1 binary variables representing selection or non-selection for each first-order term and each second-order term included in a learning model constructed using FM (hereinafter also referred to as an FM model) and determines, by using an Ising model, an optimal combination of the 0-1 binary variables. This processing corresponds to L0 regularization.

D: The learning device 100 introduces into the objective function a correction term that reflects classification results (success/failure) of a classification model subjected to L0 regularization.

Details of item A are explained. In evaluation of a classification problem, consider defining mean squared error (MSE) as a loss function. Here, let yₗⁱ={0, 1} be the label (ground-truth label) of the i-th data, and let yₚⁱ be a predicted value predicted by some classification model. A loss function (Loss) for N data using mean squared error (MSE) is defined by Equation (1) below.

$$\begin{matrix}[ Math . 1 ] & \\ Loss = \frac{1}{N} {\sum }_{i = 1}^{N} {( {y}_{l}^{i} - {y}_{p}^{i} )}^{2} & Equation ( 1 )\end{matrix}$$

A problem when using Equation (1) is that when the predicted value yₚⁱ is sufficiently larger than 1, the label should be predicted as “1” with high probability, but the loss increases as it becomes larger than 1. Similarly, when the predicted value yₚⁱ is sufficiently smaller than 0, the label should be predicted as “0” with high probability, but a problem occurs that the loss increases due to characteristics of squared error as it becomes smaller than 0.

Therefore, in the present example embodiment, the learning model construction unit 120 applies cross-entropy error as a loss function in a binary classification problem and uses, as an output function, a sigmoid function S_{g}(xⁱ) that converts an input value xⁱ of the i-th data into an output in the interval [0, 1]. By combining the sigmoid function and the cross-entropy error, the problem of loss increase that occurs when MSE is used is eliminated.

The sigmoid function used in the present example embodiment is defined by Equation (2) below.

$$\begin{matrix}[ Math . 2 ] & \\ {S}_{g} ( {x}^{i} ) = \frac{1}{1 + exp ( - α {f}_{FM} ( {x}^{i} ) )} & Equation ( 2 )\end{matrix}$$

In Equation (2), f_{FM}(xⁱ) is a quadratic learning model constructed by FM described later. In addition, alpha (alpha>0) is called “gain” and is a hyperparameter having a role to make the shape of the sigmoid function steeper or gentler. A loss function using cross-entropy error is defined by Equation (3) below.

$$\begin{matrix}[ Math . 3 ] & \\ Loss = - \frac{1}{N} {\sum }_{i = 1}^{N} [ {y}_{l}^{i} log \{ {S}_{g} ( {x}^{i} ) \} + ( 1 - {y}_{l}^{i} ) log \{ 1 - {S}_{g} ( {x}^{i} ) \} ] & Equation ( 3 )\end{matrix}$$

Considering partial differentiation of Equation (3) with respect to theta (a general term for coefficient parameters included in the FM model), Equation (4) below is derived.

$$\begin{matrix}[ Math . 4 ] & \\ \frac{\partial Loss}{\partial θ} = \frac{1}{N} {\sum }_{i = 1}^{N} ( {S}_{g} ( {x}^{i} ) - {y}_{l}^{i} ) ( α \frac{\partial {f}_{FM} ( {x}^{i} )}{\partial θ} ) & Equation ( 4 )\end{matrix}$$

Details of item B are explained. When an input vector is assumed to be x, a quadratic learning model F is formally expressed by Equation (5) below.

$$\begin{matrix}[ Math . 5 ] & \\ {f}_{FM} ( x ) = {w}^{( 0 )} + {\sum }_{i = 1}^{m} {w}_{i}^{( 1 )} {x}_{i} + {\sum }_{i = 1}^{m} {\sum }_{j = i + 1}^{m} {w}_{ij}^{( 2 )} {x}_{i} {x}_{j} & Equation ( 5 )\end{matrix}$$

In Equation (5), i and j are not data indices but indices to identify features. That is, each data is described by m features.

In FM, because the cross term in Equation (5) (that is, the third term on the right-hand side) is approximated by an inner product of a latent vector v, this part is expressed by Equation (6) below. The number of elements of the latent vector is K.

$$\begin{matrix}[ Math . 6 ] & \\ \begin{matrix}{f}^{( 2 )} ( x ) = {\sum }_{i = 1}^{m} {\sum }_{j = i + 1}^{m} {w}_{ij}^{( 2 )} {x}_{i} {x}_{j} \\ \approx {\sum }_{i = 1}^{m} {\sum }_{j = i + 1}^{m} ( {\sum }_{P = 1}^{K} {v}_{i}^{p} {v}_{j}^{p} ) {x}_{i} {x}_{j} \\ = \frac{1}{2} {\sum }_{p = 1}^{K} [ ( {\sum }_{i = 1}^{m} {v}_{i}^{p} {x}_{i} ) ( {\sum }_{i = 1}^{m} {v}_{j}^{p} {x}_{j} ) - {\sum }_{i = 1}^{m} {( {v}_{i}^{p} {x}_{i} )}^{2} ]\end{matrix} & Equation ( 6 )\end{matrix}$$

When f⁽²⁾(x) is partially differentiated with respect to vₐ^{q}, it becomes Equation (7) below.

$$\begin{matrix}[ Math . 7 ] & \\ \frac{\partial {f}^{( 2 )} ( x )}{\partial {v}_{a}^{q}} = {x}_{a} \{ ( {\sum }_{j = 1}^{m} {v}_{j}^{q} {x}_{j} ) - {v}_{a}^{q} {x}_{a} \} & Equation ( 7 )\end{matrix}$$

Therefore, partial derivatives of the loss function with respect to each parameter are calculated as in Equation (8) below.

$$\begin{matrix}[ Math . 8 ] & \\ \frac{\partial Loss}{\partial {w}^{( 0 )}} = \frac{1}{N} {\sum }_{i = 1}^{N} ( {S}_{g} ( {x}^{i} ) - {y}_{l}^{i} ) α , & Equation ( 8 )\end{matrix}$$

$$\frac{\partial Loss}{\partial {w}_{i}^{( 1 )}} = \frac{1}{N} {\sum }_{i = 1}^{N} ( {S}_{g} ( {x}^{i} ) - {y}_{l}^{i} ) α {x}_{i} ,$$

$$\frac{\partial Loss}{\partial {v}_{a}^{q}} = \frac{1}{N} {\sum }_{i = 1}^{N} ( {S}_{g} ( {x}^{i} ) - {y}_{l}^{i} ) α {x}_{a} \{ ( {\sum }_{j = 1}^{m} {v}_{j}^{q} {x}_{j} ) - {v}_{a}^{q} {x}_{a} \}$$

Update equations for each parameter are expressed by Equation (9) below, where r is a learning rate.

$$\begin{matrix}[ Math . 9 ] & \\ {w}^{( 0 )} \to {w}^{( 0 )} - r \frac{\partial Loss}{\partial {w}^{( 0 )}} , & Equation ( 9 )\end{matrix}$$

$${w}_{i}^{( 1 )} \to {w}_{i}^{( 1 )} - r \frac{\partial Loss}{\partial {w}_{i}^{( 1 )}} ,$$

$${v}_{a}^{q} \to {v}_{a}^{q} - r \frac{\partial Loss}{\partial {v}_{a}^{q}}$$

In the learning process of the example described later, mini-batch learning (batch size 32) was used, and stochastic gradient descent was applied with the learning rate set to 0.02. However, the learning process by the learning device 100 of the present disclosure is not limited to this method.

Details of item C are explained. The quadratic learning model expressed by Equation (5) includes m features and cross terms of features numbering m(m−1)/2. When the cross term is considered by replacing xᵢ xⱼ with xₖ, it can be regarded as a kind of feature. Thereby, the quadratic learning model expressed by Equation (5) can be regarded as being composed of a total of m(m+1)/2 effective features.

When the number of features is large, overfitting that excessively fits training data is a concern, and regularization becomes necessary. In general, L1 regularization or L2 regularization is used as regularization, but in an Ising model, L0 regularization that directly controls selection/non-selection of each feature can be easily introduced. This L0 regularization is expected to improve generalization performance.

Furthermore, because L0 regularization can explicitly specify the number of selected features, it becomes clear which features dominantly contribute in a learning model. This provides an advantage of increasing model interpretability.

Therefore, in the present example embodiment, the binary-variable introduction unit 130 introduces 0-1 binary variables (Iᵢ, Iᵢⱼ) to control wᵢ⁽¹⁾ and wᵢⱼ⁽²⁾ in Equation (5). A model into which the 0-1 binary variables (Iᵢ, Iᵢⱼ) are introduced is expressed by Equation (10) below.

$$\begin{matrix}[ Math . 10 ] & \\ {f}_{FM} ( x , {I}_{i} , {I}_{ij} ) = {w}^{( 0 )} + {\sum }_{i = 1}^{m} {I}_{i} {w}_{i}^{( 1 )} {x}_{i} + {\sum }_{i = 1}^{m} {\sum }_{j = i + 1}^{m} {I}_{ij} {w}_{ij}^{( 2 )} {x}_{i} {x}_{j} & Equation ( 10 )\end{matrix}$$

Then, based on the learning model into which the binary variables are introduced, the objective-function generation unit 140 generates an objective function that is a target of optimization (minimization) by an Ising model. This regularization objective function F is expressed by Equation (11) below.

$$\begin{matrix}[ Math . 11 ] & \\ F = {\sum }_{k = 1}^{N} {( {f}_{FM} ( {x}^{k} , {I}_{i} , {I}_{ij} ) - {f}_{FM} ( {x}^{k} ) )}^{2} + A {\{ ( {\sum }_{i = 1}^{m} {I}_{i} + {\sum }_{i = 1}^{m} {\sum }_{j = i + 1}^{m} {I}_{ij} ) - M \}}^{2} - B {\sum }_{k = 1}^{N} ( 2 {y}_{l}^{k} - 1 ) {f}_{FM} ( x , {I}_{i} , {I}_{ij} ) & Equation ( 11 )\end{matrix}$$

In Equation (11), the second term on the right-hand side is a penalty function representing a constraint condition to select M of the m(m+1)/2 effective features. A on the second term on the right-hand side is a hyperparameter that adjusts the strength of the penalty.

Details of item D are explained. The third term on the right-hand side of Equation (11) has the following meaning. Because the range of the sigmoid function of Equation (2) is [0, 1], when the argument f_{FM}(x) of the exponential function is positive, the output of the sigmoid function becomes greater than ½ and predicts the label “+1.” Conversely, when the argument f_{FM}(x) is negative, the output of the sigmoid function becomes less than ½ and predicts the label “0.” Therefore, (2y₁^{k}−1)f_{FM} (x, Iᵢ, Iᵢⱼ) in the third term on the right-hand side takes a positive value when a ground-truth label and a predicted label match and lowers the value of the objective function F. On the other hand, when the ground-truth label and the predicted label do not match, this term takes a negative value and raises the value of the objective function F. That is, the third term on the right-hand side of Equation (11) works in a direction to improve prediction accuracy of the model.

### [Operation Explanation]

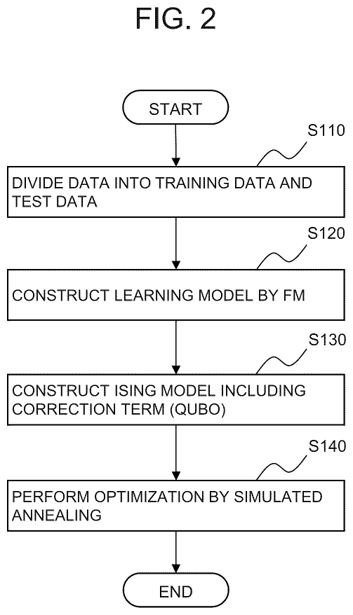

Next, the operation of the learning device is explained. FIG. 2 is a flowchart to explain an example operation of the learning device. Note that the operation example shown in FIG. 2 does not limit the operation of the learning device 100 according to the present disclosure.

The learning device 100 inputs data as classification targets and divides the data into training data and test data (step S110). Specifically, the data adjustment unit 110 inputs the data as classification targets and converts categorical variables into one-hot vectors for construction of an FM learning model and optimization by an Ising model. Thereafter, the data adjustment unit 110 randomly divides the entire data into training data and test data.

Next, the learning device 100 constructs a learning model by FM (step S120). Specifically, the learning model construction unit 120 constructs a learning model for binary classification by combining logistic regression and FM using the training data.

Next, the learning device 100 constructs an Ising model including a correction term (step S130). Specifically, the binary-variable introduction unit 130 introduces 0-1 binary variables (Iᵢ, Iᵢⱼ) representing selection or non-selection for each first-order term and each second-order term of the constructed learning model. Thereafter, based on the learning model into which the binary variables are introduced, the objective-function generation unit 140 generates an objective function that is a target of optimization (minimization) by an Ising model. At this time, the objective-function generation unit 140 introduces into the objective function a correction term that reflects classification results (success/failure) by the L0-regularized learning model. By the processing of step S130, the problem of regularizing the constructed learning model is converted into a combinatorial optimization problem described in QUBO form corresponding to an Ising model.

Next, the learning device 100 performs optimization by simulated annealing (step S140). Specifically, the solver 150 solves the converted combinatorial optimization problem and outputs a solution. For example, for features included in the constructed learning model, the solver 150 outputs the solution of the solved combinatorial optimization problem as feature selection results (that is, selection results indicating selection or non-selection of features (terms)).

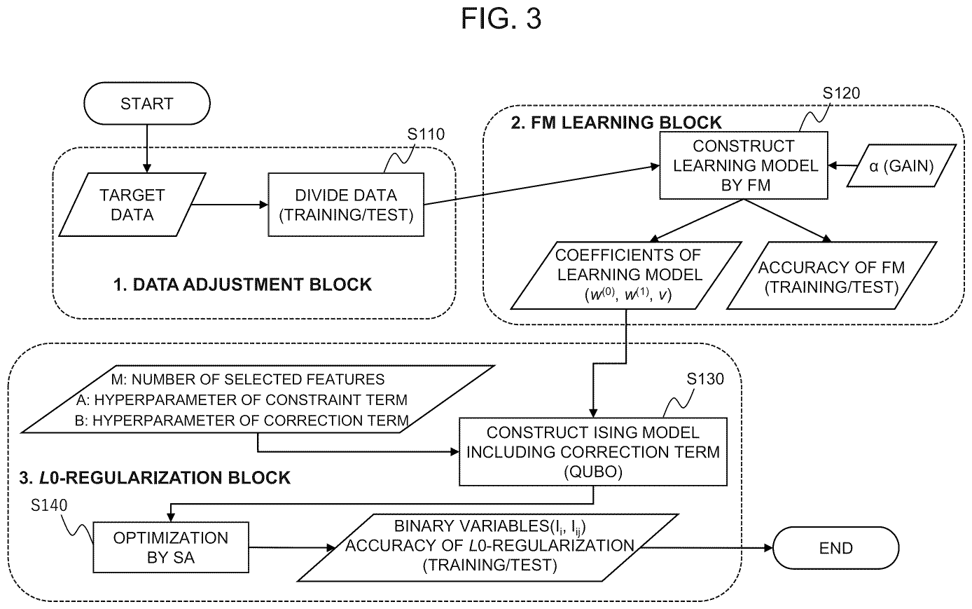

Next, an outline of the learning device according to the present disclosure is explained. FIG. 3 is an explanatory diagram to explain an outline of the operation of the learning device. Note that FIG. 3 is an explanatory diagram to facilitate understanding of the outline of the operation of the learning device. Therefore, the configuration and operation of the learning device are not limited to those shown in FIG. 3. In FIG. 3, arrows simply indicate directions of flows of signals (data) and do not exclude bidirectionality. The same applies to other drawings.

As shown in FIG. 3, processing executed by the learning device 100 can be divided into three blocks: a data adjustment block, an FM learning block, and an L0-regularization block.

In the data adjustment block, the data adjustment unit 110 inputs data serving as classification targets. Next, the data adjustment unit 110 converts categorical variables into one-hot vectors for construction of a learning model by FM and optimization by an Ising model. The data adjustment unit 110 also randomly divides the entire data into training data and test data.

In the FM learning block, the learning model construction unit 120 determines a sigmoid function having a quadratic argument using the above training data. Through learning based on FM, the learning model construction unit 120 obtains coefficients (w⁽⁰⁾, w⁽¹⁾, v) of the respective terms of the quadratic expression. Here, the learning model construction unit 120 introduces a hyperparameter alpha (gain) that adjusts the overall magnitude of the argument.

In the L0-regularization block, the binary-variable introduction unit 130 introduces 0-1 binary variables (Iᵢ, Iᵢⱼ) representing selection or non-selection for each first-order term and each second-order term included in the FM model. The objective-function generation unit 140 generates an objective function that is a target of optimization (minimization) by an Ising model based on the learning model into which the binary variables are introduced. At this time, the objective-function generation unit 140 introduces a penalty function to set the total number M of selected features (terms) and adjusts its strength by the hyperparameter A. Furthermore, the objective-function generation unit 140 introduces a correction term that reflects classification results (success/failure) by the L0-regularized classification model and sets a hyperparameter B to adjust the strength of this correction term. The solver 150 calculates a combination of values of binary variables that minimizes the generated objective function and outputs a calculation result (that is, selection results indicating selection or non-selection of features (terms)).

### [Explanation of Effects]

Next, effects of the present example embodiment are explained. In the present example embodiment, the binary-variable introduction unit 130 introduces 0-1 binary variables (Iᵢ, Iᵢⱼ) representing selection or non-selection for each first-order term and each second-order term of the constructed learning model. The objective-function generation unit 140 generates an objective function that is a target of optimization (minimization) by an Ising model based on the learning model into which the binary variables are introduced. Specifically, the objective-function generation unit 140 converts the problem of regularizing the constructed learning model into a combinatorial optimization problem described in QUBO form. This combinatorial optimization problem is a problem of selecting a combination of 0-1 binary variables (Iᵢ, Iᵢⱼ) that minimizes the objective function. As a solution method for the combinatorial optimization problem, the solver 150 uses, for example, simulated annealing or quantum annealing, solves the combinatorial optimization problem, and outputs the solution of the solved combinatorial optimization problem. For example, the solver 150 outputs the solution of the solved combinatorial optimization problem as feature selection results. With such a configuration, it is possible to achieve a learning model for binary classification optimized using an Ising model.

In addition, in the present example embodiment, the learning model construction unit 120 constructs a learning model for binary classification using logistic regression and FM. The learning model construction unit 120 uniformly adjusts the entire argument of the exponential function in logistic regression by the hyperparameter alpha (gain). With such a configuration, as shown in example 2 described later, classification accuracy can be improved.

In addition, in the present example embodiment, the objective-function generation unit 140 generates an objective function including a correction term that reflects classification results by the L0-regularized learning model. The correction term includes a hyperparameter B whose strength is adjustable. With such a configuration, as shown in example 4 described later, classification accuracy can be improved.

In the present example embodiment, the data adjustment unit 110 inputs data as classification targets having multiple features, converts categorical variables into one-hot vectors, and divides the data into training data and test data. For features included in a learning model constructed using the training data, the solver 150 outputs the solution of the solved combinatorial optimization problem as feature selection results. With such a configuration, it is possible to construct a learning model for binary classification using input classification-target data and to optimize the learning model using an Ising model.

### EXAMPLES

In this example, the well-known Titanic dataset used in Kaggle tutorials (for example, see Literature 4 below) was used. A dependent variable in this dataset is the survival status of passengers (0: deceased, 1: survived) and there are 13 explanatory variables (features). However, because a feature such as port of embarkation (Cherbourg, Queenstown, Southampton) was converted into one-hot vectors, the number of features became 18 at this point. As a result of removing missing values and the like, the total number of data became 358. This data was randomly divided so that training data and test data were in a ratio of 7:3. In the learning process, mini-batch learning (batch size 32) was used, and stochastic gradient descent with the learning rate set to 0.02 was applied. Note that the learning process by the learning device 100 of the present disclosure is not limited to this method.
Literature 4: “Titanic-Machine Learning from Disaster,” [online], [searched on Dec. 4, 2024], Internet URL: https://www.kaggle.com/c/titanic/data.

### Example 1

In example 1, a comparison was made between the proposed technique according to the present disclosure (that is, the processing executed by the learning device 100) and a general technique. In this example, logistic regression was used as a general technique to solve a binary classification task by machine learning. When accuracy of classification was examined, accuracy for training data was 84.00% and accuracy for test data was 77.78%. This result is for a case of performing L2 regularization. On the other hand, when L2 regularization is not performed, accuracy for training data was 83.60% and accuracy for test data was 76.85%. Here, when generalization performance is defined as accuracy for test data, because the number of features is 18 and relatively small, an improvement effect of generalization performance by L2 regularization was observed, but it was found that the effect was not significant. As an evaluation criterion of the proposed technique according to the present disclosure, accuracy for test data when considering L2 regularization is used.

### Example 2

In example 2, hyperparameters are adjusted. The proposed technique according to the present disclosure includes several hyperparameters, and representative ones are alpha (gain) in Equation (2) and A and B in Equation (11). The hyperparameter A has a role to adjust the strength of a constraint term to fix the number of selected features to a specific value M. Usually, by assuming A=1, this constraint condition is satisfied. However, when this condition is not satisfied, A is increased twofold (for example, A=1->2->4). The value of M is examined in example 3. The hyperparameter B has a role to adjust the strength of a correction term introduced with expectation of improving accuracy. Its value is examined in example 4, and in this example focus is placed on alpha.

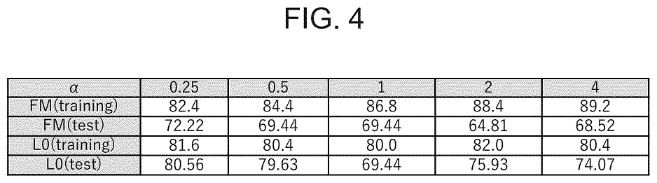

FIG. 4 is an explanatory diagram to explain an influence on accuracy when the hyperparameter alpha of the sigmoid function is adjusted. The table shown in FIG. 4 shows, for alpha={0.25, 0.5, 1, 2, 4}, accuracy by an FM model before applying L0 regularization and accuracy obtained after applying L0 regularization using an Ising model, for training data and test data, respectively. Note that parameters other than alpha were fixed to M=10, A=1 (however, A=4 when alpha=0.25), and B=1.

Comparing accuracy for test data between the original FM model and after L0 regularization, it is found that accuracy greatly improved due to L0 regularization except for alpha=1. In example 1, the improvement effect by regularization was small, but the reason why a large improvement is observed here is considered to be that FM includes cross terms as features and the number of features increases from the original 18 to 153, making effects of regularization significant. In the results shown in FIG. 4, particularly notable are cases of alpha=0.25 and alpha=0.5. Their accuracies were 80.56% and 79.63%, respectively, exceeding the accuracy for test data (77.78%) by general logistic regression considering L2 regularization in example 1. These results show effectiveness of the hyperparameter alpha in the proposed technique according to the present disclosure.

### Example 3

In example 3, a relation between the number of features (M) selected by L0 regularization and accuracy was examined. Here, cases of alpha=0.25 and alpha=0.5, for which accuracy was good in the table shown in FIG. 4 explained in example 2, were examined. Values of A were set to A=4 (alpha=0.25), A=1 (alpha=0.5, M equal to or more than 10), or A=2 (alpha=0.5, M=8 or 6). The value of B was always fixed to 1.

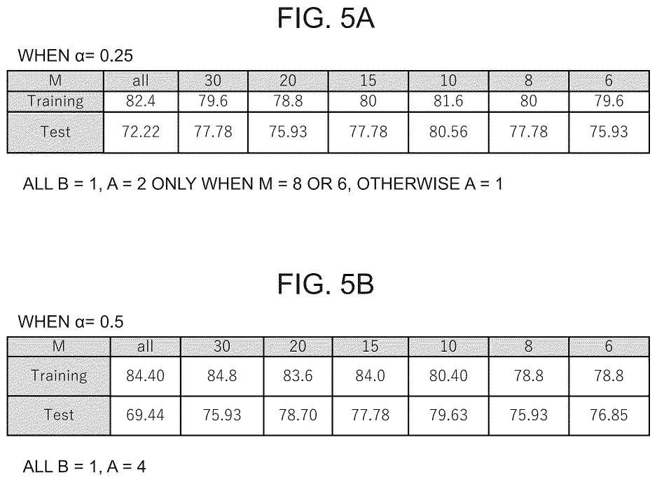

FIG. 5A and FIG. 5B are an explanatory diagram to explain a relation between the number of features (M) selected by L0 regularization and accuracy. The table shown in FIG. 5A shows accuracy for training data and for test data when alpha=0.25. The table shown in FIG. 5B shows accuracy for training data and for test data when alpha=0.5. Results obtained for alpha=0.25 and alpha=0.5 are similar, and accuracy for test data was relatively good particularly when M is equal to or less than 30. As also stated in example 2, cases exceeding accuracy (77.78%) by a general logistic regression model were confirmed. Because the number of features in the original data without cross terms is 18, cases with M equal to or less than 10 mean that a model having accuracy equal to or better than a general classification model was constructed with about half the features. As a result, it is expected that interpretability of the model increases because the number of features decreases.

### Example 4

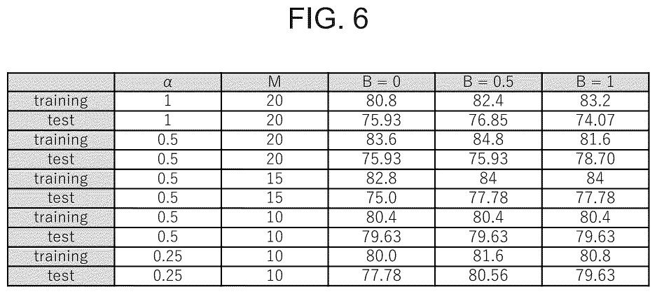

In example 4, effects of the correction term were examined. FIG. 6 is an explanatory diagram to explain an influence that the correction term of Equation (11) gives to accuracy. The last term on the right-hand side of Equation (11) is a correction term introduced with expectation of improving accuracy. In this example, cases without considering this correction term (B=0) and cases changing the strength of the correction term (B=0.5 or 1) were examined. Using several representative combinations of alpha and M, accuracy for training data and for test data was compared. FIG. 6 shows the comparison results. A particularly notable quantity is accuracy for test data. The higher of accuracies in cases considering the correction term (B=0.5 or 1) is equal to or higher than accuracy in a case not considering the correction term (B=0). From this result, effectiveness of the correction term is confirmed.

As described above, the learning device 100 of the example embodiment achieves a learning model for binary classification optimized using an Ising model. Therefore, in the examples above, it was confirmed that a learning model for binary classification optimized using an Ising model and having accuracy equal to or exceeding that of general techniques can be achieved.

Each component in the example embodiment and the examples above can be configured by one hardware, but can also be configured by one software. Each component can be configured by a plurality of hardware and can also be configured by a plurality of software. Some of the components can be configured by hardware and other parts can be configured by software.

Each function (each process) in the example embodiment can be achieved by a computer having a processor, a memory, and the like. For example, a program for executing the method (process) in the example embodiment is stored in a storage device (storage medium), and each function can be achieved by executing the program stored in the storage device by a processor.

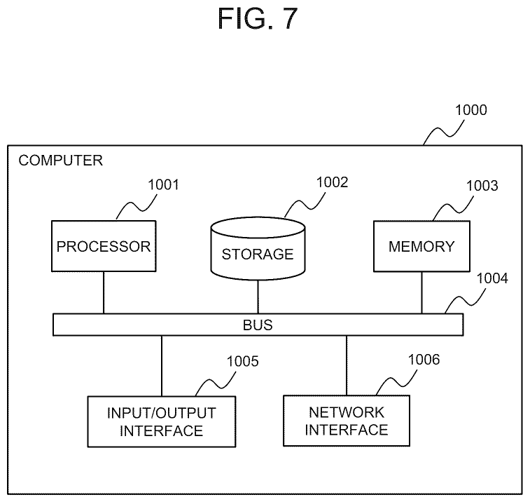

FIG. 7 is a block diagram to explain a hardware configuration of a computer 1000. The computer 1000 is an arbitrary computer. For example, the computer 1000 is a stationary computer such as a personal computer or a server machine. For example, the computer 1000 is a portable computer such as a smartphone or a tablet terminal. The computer 1000 may be a dedicated computer designed to achieve a signal processing apparatus or a signal processing system, or may be a general-purpose computer.

The computer 1000 has a processor 1001, a storage device 1002, a memory 1003, a bus 1004, an input/output interface 1005, and a network interface 1006.

The processor 1001 is various processing devices such as a CPU (Central Processing Unit), a GPU (Graphics Processing Unit), an FPGA (Field-Programmable Gate Array), and a DSP (Digital Signal Processor).

The storage device 1002 is, for example, a non-transitory computer-readable medium. The non-transitory computer-readable medium includes various types of tangible storage media. Specific examples of the non-transitory computer-readable medium include semiconductor memories (for example, mask ROM, PROM (Programmable ROM), EPROM (Erasable PROM), and flash ROM).

The memory 1003 is a main storage device achieved by using RAM (Random Access Memory) or the like. The memory 1003 temporarily stores data when the processor 1001 executes processing.

The bus 1004 is a data transmission path for the processor 1001, the memory 1003, the storage device 1002, the input/output interface 1005, and the network interface 1006 to send and receive data to and from each other. However, a method of connecting the processor 1001 and the like to each other is not limited to a bus connection.

The input/output interface 1005 is an interface to connect the computer 1000 and input/output devices. For example, an input device such as a keyboard and an output device such as a display device are connected to the input/output interface 1005.

The network interface 1006 is an interface to connect the computer 1000 to a network. The network may be a LAN (Local Area Network) or may be a WAN (Wide Area Network).

The storage device 1002 stores programs to achieve functional configuration units in the example embodiment and the examples. The processor 1001 reads the programs into the memory 1003 and executes them to achieve the functional configuration units in the example embodiment and the examples.

The learning device 100 may be achieved by one computer 1000, or may be achieved by a plurality of computers 1000. In the latter case, configurations of the computers 1000 need not be identical and can be different from each other.

The functional configuration units in the example embodiment and the examples can be achieved by a combination of the hardware and the software described above, or can be achieved by hardware (for example, hardwired electronic circuits).

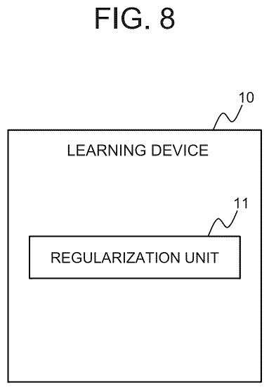

Next, an outline of the present disclosure is explained. FIG. 8 is a block diagram to explain main parts of the learning device. A learning device 10 shown in FIG. 8 (for example, corresponding to the learning device 100) includes a regularization unit 11 that performs L0 regularization of features included in a learning model for binary classification constructed using logistic regression and a Factorization Machine by using an Ising model (in the example embodiment, for example, the binary-variable introduction unit 130, the objective-function generation unit 140, and the solver 150 achieve the regularization unit 11). With such a configuration, it is possible to achieve a learning model for binary classification optimized using an Ising model.

The learning device 10 shown in FIG. 8 may take a configuration including a learning unit (in the example embodiment, for example, achieved by the learning model construction unit 120) that constructs a learning model for binary classification using logistic regression and a factorization machine. The learning unit uniformly adjusts the entire argument of the exponential function in logistic regression by a hyperparameter (in the example embodiment, corresponding to the hyperparameter alpha). With such a configuration, as shown in example 2, classification accuracy can be improved.

The regularization unit 11 may perform L0 regularization of features using an objective function including a correction term that reflects classification results by an L0-regularized learning model. The correction term includes a hyperparameter (for example, corresponding to the hyperparameter B) whose strength is adjustable. With such a configuration, as shown in example 4, classification accuracy can be improved.

The learning device 10 shown in FIG. 8 may take a configuration including an adjustment unit (in the example embodiment, for example, achieved by the data adjustment unit 110) that inputs data as a classification target having multiple features, converts categorical variables into one-hot vectors, and divides the data into training data and test data. The regularization unit 11 introduces binary variables representing selection or non-selection for each first-order term and each second-order term of a learning model for binary classification constructed using training data. Then, the regularization unit 11 generates an objective function based on the learning model into which the binary variables are introduced. Furthermore, the regularization unit 11 solves a combinatorial optimization problem that selects a combination of binary variables that minimizes the objective function described in QUBO form. Thereafter, for features included in the constructed learning model, the regularization unit 11 outputs the solution of the solved combinatorial optimization problem as feature selection results. With such a configuration, it is possible to construct a learning model for binary classification using input classification-target data and to optimize the learning model using an Ising model.

Although the present disclosure has been explained with reference to example embodiments and examples, the present disclosure is not limited to the above example embodiments and examples. Various changes can be made to configurations and details of the present disclosure within the scope of the present disclosure that can be understood by those skilled in the art. Each example embodiment and example can be combined with other example embodiments and examples as appropriate.

The drawings are merely examples to explain one or more example embodiments or examples. The drawings are not associated with only one specific example embodiment or example and may be associated with one or more other example embodiments or examples. As will be understood by those skilled in the art, various features or steps explained with reference to any one drawing can be combined with features or steps shown in one or more other drawings to create, for example, example embodiments not explicitly illustrated or explained. Not all features or steps shown in any one drawing to explain an example embodiment are necessarily essential, and some features or steps may be omitted. Orders of steps described in any drawing may be changed as appropriate.

Some or all of the above example embodiments and examples can also be described as in the Supplementary notes below, but are not limited to the following.

### (Supplementary Note 1)

A learning device comprising
a regularization unit that performs L0 regularization of features included in a learning model for binary classification constructed using logistic regression and a Factorization Machine by using an Ising model.

### (Supplementary Note 2)

The learning device according to Supplementary note 1, wherein
the regularization unit introduces binary variables representing selection or non-selection for each first-order term and each second-order term of the constructed learning model for binary classification and performs L0 regularization of features by determining an optimal combination of the binary variables using an Ising model.

### (Supplementary Note 3)

The learning device according to Supplementary note 2, wherein
the regularization unit generates an objective function based on the learning model into which the binary variables are introduced, solves a combinatorial optimization problem that is a problem of selecting a combination of binary variables that minimizes the objective function described in QUBO (Quadratic Unconstrained Binary Optimization) form, and outputs a solution of the solved combinatorial optimization problem.

### (Supplementary Note 4)

The learning device according to Supplementary note 3, further comprising
an adjustment unit that inputs data as a classification target having multiple features, converts categorical variables into one-hot vectors, and divides the data into training data and test data, wherein
for features included in a learning model for binary classification constructed using the training data, the regularization unit outputs the solution of the solved combinatorial optimization problem as feature selection results.

### (Supplementary Note 5)

The learning device according to any one of Supplementary notes 1 to 4, comprising
a learning unit that constructs a learning model for binary classification using logistic regression and a Factorization Machine, wherein
the learning unit uniformly adjusts the entire argument of the exponential function in logistic regression by a hyperparameter.

### (Supplementary Note 6)

The learning device according to Supplementary note 5, wherein
the learning unit sets the argument part of the exponential function in logistic regression to a quadratic learning model by a Factorization Machine and uniformly adjusts the overall magnitude of the quadratic learning model by a hyperparameter.

### (Supplementary Note 7)

The learning device according to any one of Supplementary notes 1 to 4, wherein
the regularization unit performs L0 regularization of features using an objective function including a correction term that reflects classification results by an L0-regularized learning model.

### (Supplementary Note 8)

The learning device according to Supplementary note 7, wherein
the correction term includes a hyperparameter whose strength is adjustable.

### (Supplementary Note 9)

A learning method, performed by a computer and comprising
performing L0 regularization of features included in a learning model for binary classification constructed using logistic regression and a Factorization Machine by using an Ising model.

### (Supplementary Note 10)

A learning program for causing a computer to execute
performing L0 regularization of features included in a learning model for binary classification constructed using logistic regression and a Factorization Machine by using an Ising model.

### (Supplementary Note 11)

A non-transitory computer readable recording medium storing a learning program executable by a computer to perform processing comprising
performing L0 regularization of features included in a learning model for binary classification constructed using logistic regression and a Factorization Machine by using an Ising model.

Some or all of elements (for example, configurations and functions) described in Supplementary notes 2 to 8 depending on Supplementary note 1 can depend on Supplementary notes 9, 10, and 11 in the same dependency manner as in Supplementary notes 2 to 8. Some or all of elements described in any Supplementary note can be applied to various hardware, software, recording means for recording software, systems, and methods.

1. A learning device comprising:
a memory storing software instructions; and
one or more processors configured to execute the software instructions to:
perform L0 regularization of features included in a learning model for binary classification constructed using logistic regression and a Factorization Machine by using an Ising model.

2. The learning device according to claim 1, wherein
the one or more processors introduce binary variables representing selection or non-selection for each first-order term and each second-order term of the constructed learning model for binary classification and perform L0 regularization of features by determining an optimal combination of the binary variables using an Ising model.

3. The learning device according to claim 2, wherein
the one or more processors generate an objective function based on the learning model into which the binary variables are introduced, solve a combinatorial optimization problem that is a problem of selecting a combination of binary variables that minimizes the objective function described in QUBO (Quadratic Unconstrained Binary Optimization) form, and output a solution of the solved combinatorial optimization problem.

4. The learning device according to claim 3, wherein the one or more processors are further configured to execute the software instructions to
input data as a classification target having multiple features, convert categorical variables into one-hot vectors, and divide the data into training data and test data, wherein
for features included in a learning model for binary classification constructed using the training data, the one or more processors output the solution of the solved combinatorial optimization problem as feature selection results.

5. The learning device according to claim 1, wherein the one or more processors are further configured to execute the software instructions to
construct the learning model for binary classification using logistic regression and a Factorization Machine, wherein
the one or more processors uniformly adjust the entire argument of an exponential function in logistic regression by a hyperparameter.

6. The learning device according to claim 5, wherein
the one or more processors set the argument part of the exponential function in logistic regression to a quadratic learning model by a Factorization Machine and uniformly adjust the overall magnitude of the quadratic learning model by a hyperparameter.

7. The learning device according to claim 1, wherein
the one or more processors perform L0 regularization of features using an objective function including a correction term that reflects classification results by an L0-regularized learning model.

8. The learning device according to claim 7, wherein
the correction term includes a hyperparameter whose strength is adjustable.

9. A learning method performed by a computer and comprising:
performing L0 regularization of features included in a learning model for binary classification constructed using logistic regression and a Factorization Machine by using an Ising model.

10. A non-transitory computer readable medium storing a learning program executable by a computer to perform processing comprising:
performing L0 regularization of features included in a learning model for binary classification constructed using logistic regression and a Factorization Machine by using an Ising model.

11. The learning device according to claim 2, wherein the one or more processors are further configured to execute the software instructions to
construct the learning model for binary classification using logistic regression and a Factorization Machine,
wherein the one or more processors uniformly adjust the entire argument of an exponential function in logistic regression by a hyperparameter.

12. The learning device according to claim 3, wherein the one or more processors are further configured to execute the software instructions to
construct the learning model for binary classification using logistic regression and a Factorization Machine, wherein
the one or more processors uniformly adjust the entire argument of an exponential function in logistic regression by a hyperparameter.

13. The learning device according to claim 4, wherein the one or more processors are further configured to execute the software instructions to
construct the learning model for binary classification using logistic regression and a Factorization Machine, wherein
the one or more processors uniformly adjust the entire argument of an exponential function in logistic regression by a hyperparameter.

14. The learning device according to claim 11, wherein
the one or more processors set the argument part of the exponential function in logistic regression to a quadratic learning model by a Factorization Machine and uniformly adjust the overall magnitude of the quadratic learning model by a hyperparameter.

15. The learning device according to claim 12, wherein
the one or more processors set the argument part of the exponential function in logistic regression to a quadratic learning model by a Factorization Machine and uniformly adjust the overall magnitude of the quadratic learning model by a hyperparameter.

16. The learning device according to claim 13, wherein
the one or more processors set the argument part of the exponential function in logistic regression to a quadratic learning model by a Factorization Machine and uniformly adjust the overall magnitude of the quadratic learning model by a hyperparameter.

17. The learning device according to claim 2, wherein
the one or more processors perform L0 regularization of features using an objective function including a correction term that reflects classification results by an L0-regularized learning model.

18. The learning device according to claim 3, wherein
the one or more processors perform L0 regularization of features using an objective function including a correction term that reflects classification results by an L0-regularized learning model.

19. The learning device according to claim 4, wherein
the one or more processors perform L0 regularization of features using an objective function including a correction term that reflects classification results by an L0-regularized learning model.
